(19) United States
(12) Patent Application Publication
(10) Pub. No.: US 2009/0026760 A1
(43) Pub. Date: Jan. 29, 2009

(54) HOSE COUPLING ASSEMBLY

(75) Inventor: Ty A. Henry, Mantua, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Eaton Corporation, Cleveland, OH (US)

(21) Appl. No.: 12/023,667

(22) Filed: Jan. 31, 2008

Related U.S. Application Data
(60) Provisional application No. 60/887,542, filed on Jan. 31, 2007.

(51) Int. Cl. F16L 33/01

(52) U.S. Cl. 285/148.16

(57) ABSTRACT

A hose coupling assembly for attachment to a hose having an inner surface and an outer surface. The hose coupling assembly includes a first member (e.g., a nipple) and second member (e.g., a socket). The nipple includes a tapered outer surface, an outwardly facing groove extending inwardly from the tapered outer surface, and a set of external threads disposed rearward of the tapered outer surface. An annular seal is positioned within the groove. The socket includes a nipple receiving portion and a hose receiving portion secured to the outer surface of the hose, where the nipple receiving portion has a set of internal threads configured to mesh with and threadingly engage the external threads on the nipple. Upon insertion of the nipple into the nipple receiving portion of the socket and the subsequent threading of the external threads of the nipple into the internal threads in the socket, the annular seal on the nipple sealingly engages the inner surface of the hose.

### CROSS-REFERENCE TO RELATED APPLICATION

This application claims the benefit of priority of U.S. Provisional Application No. 60/887,542 filed on Jan. 31, 2007, which is hereby incorporated by reference in its entirety herein.

### BACKGROUND

1. Field of the Invention

The present application relates to a hose coupling assembly and, more specifically, to a hose coupling assembly for use in high performance fluid systems, such as air conditioning systems.

2. Description of the Related Art

Fluid conveying hose coupling assemblies are well known in the art for transferring a fluid between two or more systems that cannot be linked by a rigid conduit. Due to an increasing demand for higher performance fluid systems, it is becoming increasingly difficult for traditional hose coupling assemblies to satisfactorily operate without leakage, particularly in high pressure fluid systems and/or fluid systems that convey a fluid that is notoriously difficult to contain, such as a refrigerant. Accordingly, there continues to be a need for improved hose coupling assemblies that can reduce or prevent fluid leakage when used in high performance fluid systems.

### SUMMARY

A hose coupling assembly for attachment to a hose is provided. The hose coupling assembly includes a first member (e.g., a nipple) and second member (e.g., a socket). The nipple includes a tapered outer surface, an outwardly facing groove extending inwardly from the tapered outer surface, and a set of external threads disposed rearward of the tapered outer surface. An annular seal is positioned within the groove. The socket includes a nipple receiving portion and a hose receiving portion secured to an outer surface of the hose, where the nipple receiving portion has a set of internal threads configured to mesh with and threadingly engage the external threads on the nipple. Upon insertion of the nipple into the nipple receiving portion of the socket and the subsequent threading of the external threads of the nipple into the internal threads in the socket, the annular seal on the nipple sealingly engages an inner surface of the hose.

A nipple assembly for use with a socket is provided. The socket includes a nipple receiving portion having a set of internal threads and a hose receiving portion secured to a hose having an inner surface and an outer surface. The nipple assembly includes a nipple having a tapered outer surface, an outwardly facing groove extending inwardly from the tapered outer surface, and a set of external threads disposed rearward of the tapered outer surface. The set of external threads is configured to mesh with and threadingly engage the internal threads in the socket. An annular seal is positioned within the groove. Upon insertion of the nipple into the nipple receiving portion of the socket and the subsequent threading of the external threads of the nipple into the internal threads in the socket, the annular seal on the nipple sealingly engages the inner surface of the hose.

### BRIEF DESCRIPTION OF THE DRAWINGS

It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIGS. 1A and 1B illustrate cross-sectional views of one embodiment of a hose coupling assembly 10 in its uncoupled and coupled positions, respectively.

FIG. 2 illustrates a cross-sectional view of one exemplary groove 54 provided in the tapered surface 52 of the nipple 14.

FIGS. 3A-3E illustrate cross-sectional views of the hose coupling assembly 10 at various stages during assembly of the hose coupling assembly 10 to a hose H.

### DETAILED DESCRIPTION

Certain terminology will be used in the foregoing description for convenience in reference only and will not be limiting. The terms “forward” and “rearward” with respect to each component of the coupling assembly will refer to direction towards and away from, respectively, the coupling direction. The terms “rightward” and “leftward” will refer to directions in the drawings in connection with which the terminology is used. The terms “inwardly” and “outwardly” will refer to directions toward and away from, respectively, the geometric centerline of the coupling assembly. The terms “upward” and “downward” will refer to directions as taken in the drawings in connection with which the terminology is used. All foregoing terms mentioned above include the normal derivative and equivalents thereof.

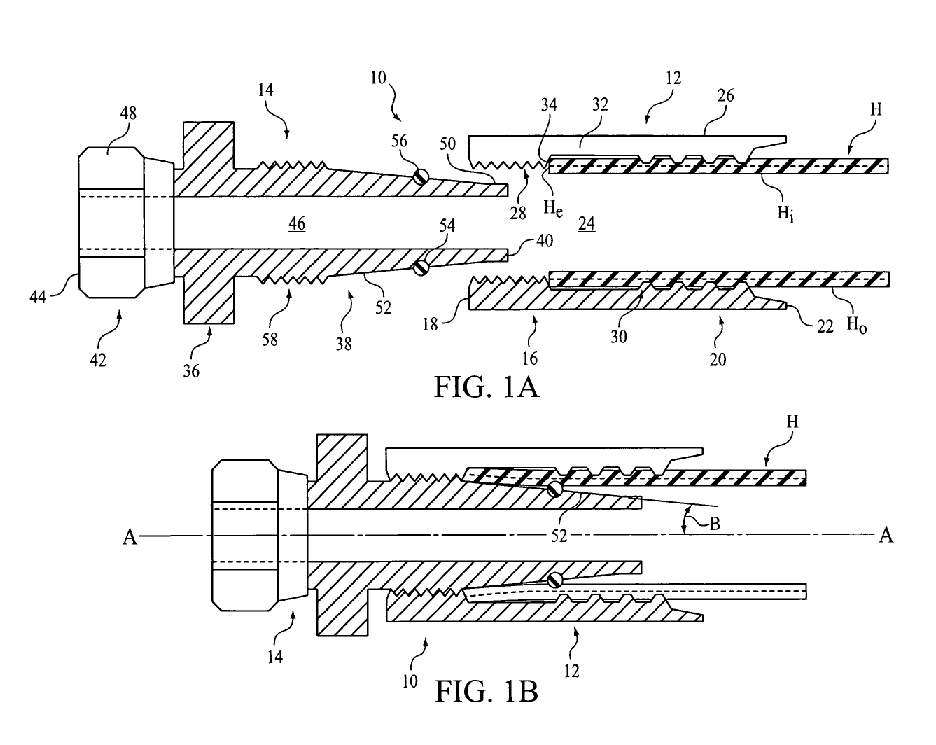

Illustrated in FIGS. 1A and 1B are cross-sectional views of one embodiment of a hose coupling assembly 10 shown in its uncoupled position and coupled position, respectively. The hose coupling assembly 10 includes a first member 12 and a second member 14. Together, the first member 12 and the second member 14 operate as a hose coupling assembly configured to be secured and sealed to a hose H, which will be discussed in further detail below. The first member 12 generally functions as the “female” member of the hose coupling assembly 10 and the second member 14 generally functions as the “male” member of the hose coupling assembly 10, such that the first member 12 is configured to receive the second member 14 at one end and the hose H at its other end. The first and second members 12, 14 share the same central longitudinal axis A when they are in the coupled position as shown in FIG. 1B.

In one embodiment, the first and second members 12, 14 can be formed of stainless steel. In alternative embodiments, the first and second members 12, 14 can be formed of other materials, such as brass, aluminum, carbon steel, and plastic.

The hose coupling assembly 10 can be used with any type of fluid conveying hose known in the art. In one specific non-limiting application, the hose coupling assembly 10 can be used with large diameter barrier-style hoses employed in air conditioning systems where the hoses are designed to convey a refrigerant. For purposes of this application, the hose H will be described with reference to a front end Hₑ, an inner surface Hᵢ, and an outer surface Hₒ.

In the illustrated embodiment, the first member 12 is configured as a socket (hereinafter “socket 12”) that includes a nipple receiving portion 16 having a nipple receiving end 18 and a hose receiving portion 20 having a hose receiving end 22. Extending through the socket 12 between its nipple receiving end 18 and its hose receiving end 22 is a passageway 24 for permitting fluid to pass therethrough. In one embodiment, the socket 12 includes an exterior surface 26 that includes a tool engaging feature, such as a series of flats (not shown), for accommodating use of a tool, such as a wrench, to secure the socket 12 to the second member 14.

The nipple receiving portion 16 of the socket 12 includes a first set of internal threads 28 located adjacent the nipple receiving end 18. In the illustrated embodiment, each thread of the first set of internal threads 28 has a triangular-shaped profile. In alternative embodiments (not shown), the threads 28 can take the form of other profiles (e.g., trapezoidal, square, or rectangular).

The hose receiving portion 20 of the socket 12 includes a retaining formation located adjacent the hose receiving end 22 and configured to engage the outer surface Hₒ of the hose H. In the illustrated embodiment, the retaining formation includes a second set of internal threads 30 having a minor diameter that is sized slightly smaller than the outer surface Hₒ of the hose H, such that the internal threads 30 are capable of engaging the outer surface Hₒ of the hose H and at least partially deforming it. In the illustrated embodiment, each thread of the second set of threads 30 has a trapezoidal-shaped profile. In alternative embodiments (not shown), the threads 30 can take the form of other profiles (e.g., triangular, square, or rectangular). Additionally, in alternative embodiments (not shown), the retaining formation can include a plurality of discrete radially outward extending projections or protrusions that are capable of engaging the outer surface Hₒ of the hose H and at least partially deforming it. In these embodiments, the plurality of discrete radially outward extending projections or protrusions can take the form of any shape and can be arranged in any pattern, so long as they are capable of engaging the outer surface Hₒ of the hose H and at least partially deforming it.

The socket 12 also includes an inner cylindrical surface 32 located between the first set of internal threads 28 and the second set of internal threads 30. The inner surface 32 is separated from the first set of internal threads 28 by a shoulder 34, which serves to limit forward axial movement of the hose H. Although the shoulder 34 is present in the illustrated embodiment, it will be appreciated that the shoulder 34 is optional and the socket 12 need not include the shoulder.

In the illustrated embodiment, the second member 14 is configured as a nipple (hereinafter “nipple 14”) that includes a collar 36 that separates a leading portion 38 having a leading end 40 and a trailing portion 42 having a trailing end 44. Optionally, the collar 36 may include a tool engaging feature, such as a series of flats (not shown), for accommodating use of a tool, such as a wrench. Extending through the nipple 14 from its leading end 40 to its trailing end 44 is a passageway 46.

The trailing portion 42 of the nipple 14 includes a flange portion (not shown) and a hex nut 48 crimped over the flange portion. The hex nut 48 includes internal threads (not shown) for attachment to a threaded coupling of another component. Alternatively, the trailing portion 42 of the nipple 14 can include other suitable attachment means for attachment to another component.

Extending rearward from the leading end 40 of the nipple 14 is an outer cylindrical surface 50 that is sized for receipt by the minor diameter of the first set of internal threads 28 of the socket 12. Extending rearward and outward from the outer surface 50 is a tapered surface 52 that is oriented at an angle B relative to the longitudinal axis A. In the illustrated embodiment, the angle B is about 5°. In alternative embodiments (not shown), the angle B can be between about 1° and about 45°. By virtue of being tapered, the tapered surface 52 has an outer diameter that increases in the direction from the leading end 40 towards the trailing end 44 of the nipple 14, thereby enabling the tapered surface 52 to act as a “wedge” when the nipple 14 is moved axially into the socket 12, which will be described in more detail below. Although the illustrated embodiment shows the tapered surface 52 having a linear profile, it will be appreciated that the tapered surface 52 can be a curved surface (e.g., convex or concave).

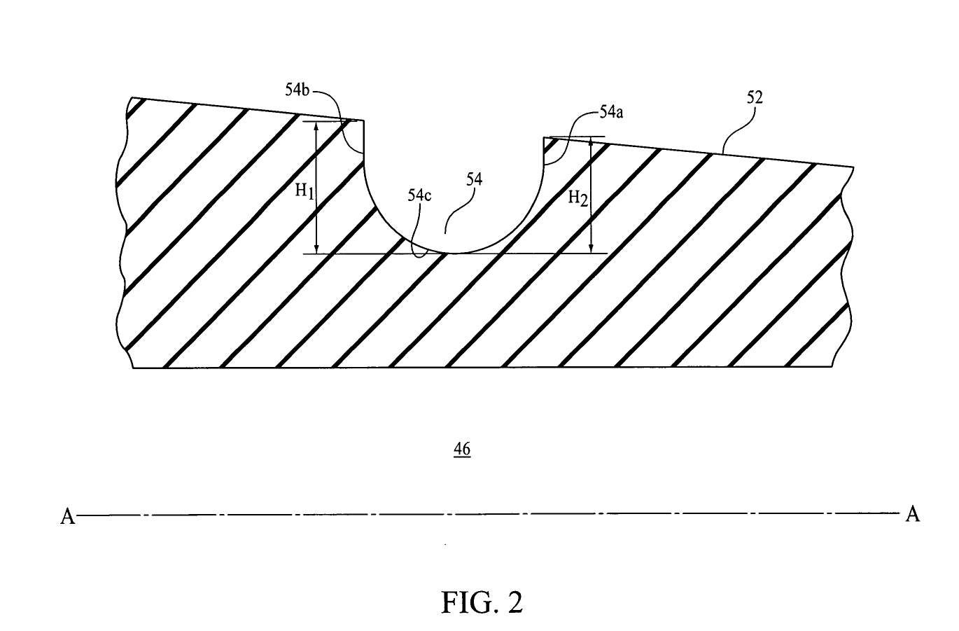

In the illustrated embodiment, the tapered surface 52 of the nipple 14 includes an outwardly facing annular groove 54 extending radially inward therefrom. As shown in FIG. 2, the groove 54 has a U-shaped profile that is oriented substantially perpendicular to the longitudinal axis A of the hose coupling assembly 10. The groove 54 is defined by a front wall 54a, a rear wall 54b, and a bottom curved wall 54c joining the front and rear walls 54a, 54b. It will be appreciated that by virtue of the groove 54 being provided in the tapered surface 52, the rear wall 54b has a height H₁ that is greater than the height H₂ of the front wall 54a, where the heights are measured from the base of the groove 54. In alternative embodiments, the groove 54 can take the form of other profiles including, without limitation, V-shaped, semi-circular, arcuate (e.g., convex), square, or rectangular. Moreover, in alternative embodiments (not shown), the tapered surface 52 can include two or more outwardly facing annular grooves provided therein.

Unlike prior art nipples that rely solely on the tapered surface of the nipple to create a seal between the nipple and the hose, the hose coupling assembly 10 includes an annular seal 56 positioned within the groove 54. The annular seal 56 is sized to be received by and to sealingly engage the inner surface Hᵢ of the hose H when the hose H is installed in the socket 12. As shown in FIG. 1A, the annular seal 56 extends beyond the tapered surface 52 of the nipple 14. The annular seal 56 can be constructed of, for example, neoprene or any other suitable sealing material.

Extending rearward from the tapered surface 52 is a set of external threads 58 that are configured to mesh with and threadingly engage the first set of internal threads 28 in the socket 12. Due to the threading engagement between the nipple 14 and the socket 12, the nipple 14 can move axially relative to the socket 12 and vice versa.

A method of assembling the hose coupling assembly 10 to the hose H will now be described. It will be appreciated that the following method is only one exemplary assembly method and other assembly methods are possible.

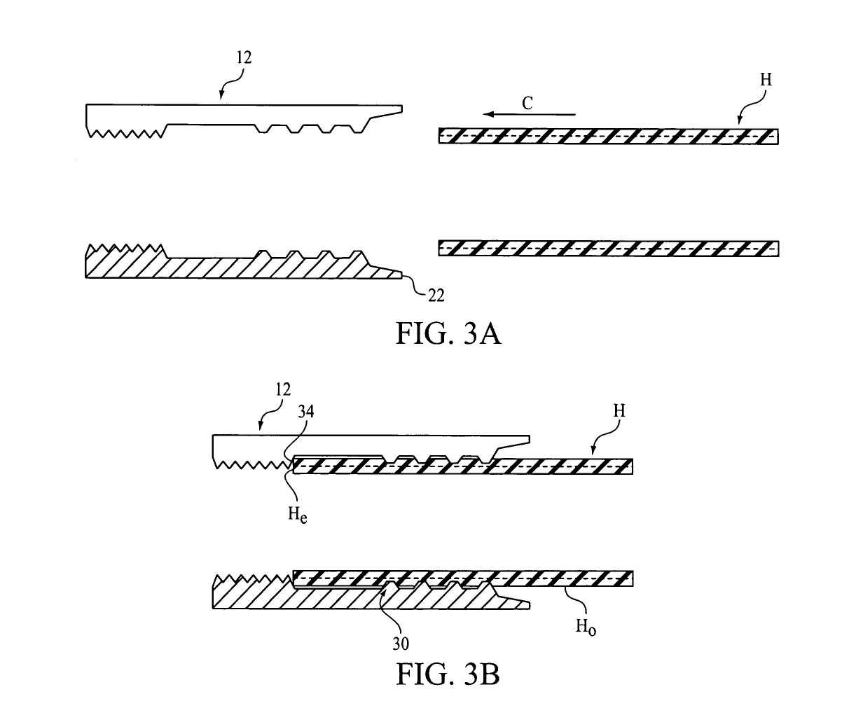

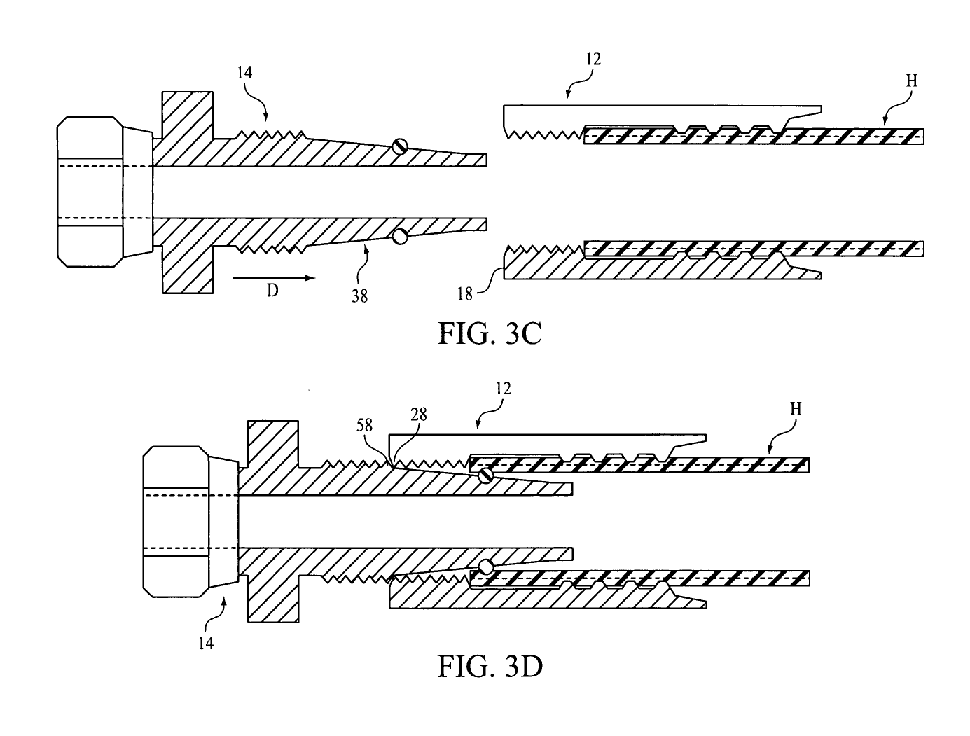

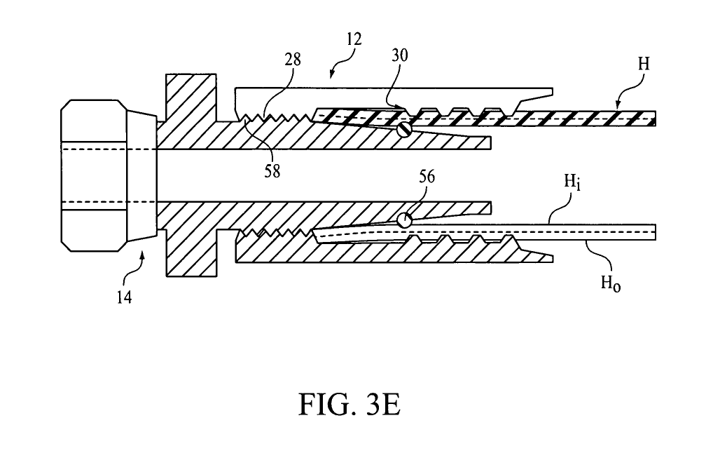

First, the hose H is inserted into the socket 12 through the hose receiving end 22 in the direction of arrow C (FIG. 3A). Once the forward end Hₑ of the hose H engages the rearward most internal thread 30 in the socket 12, the socket 12 is threaded onto the hose H until the forward end Hₑ of the hose H abuts against the shoulder 34 (FIG. 3B) or slightly spaced therefrom. Since the outer surface Hₒ of the hose H has a slightly larger diameter than the minor diameter of the second set of internal threads 30, the second set of internal threads 30 will engage and “bite” into the hose H, thereby securing the hose H to the socket 12.

To couple the nipple 14 to the socket 12, the leading portion 38 of the nipple 14 is inserted into the socket 12 through the nipple receiving end 16 thereof in the direction of arrow D (FIG. 3C). The nipple 14 is inserted into the socket 12 until the forward most external thread 58 of the nipple 14 engages the forward most internal thread 28 of the socket 12 (FIG. 3D). The nipple 14 is then threaded into the socket 12 via the threaded engagement between the external threads 58 of the nipple 14 and the first set of internal threads 28 of the socket 12. Upon continued threading of the nipple 14 into the socket 12, which causes the nipple 14 to move axially forward into the socket 12, the tapered surface 52 of the nipple 14 is drawn closer to the inner surface Hᵢ of the hose H. This is due to the fact that the tapered surface 52 has an outer diameter that increases in the direction from the leading end 40 towards the trailing end 44 of the nipple 14. Additionally, it will be appreciated that since the rear wall 54b of the groove 54 in the tapered surface 52 is taller than the front wall 54a, roll out of the annular seal 56 is prevented during axial movement of the nipple 14 into the socket 12.

Once the nipple 14 has been completely threaded into the socket 12, the hose H is “wedged” between the tapered surface 52 of the nipple 14 and the socket 12, thereby securing the hose H between the nipple 14 and the socket 12. Additionally, the annular seal 56 on the nipple 14 is sealingly engaged to the inner surface Hᵢ of the hose H, thereby preventing fluid leakage (FIG. 3E).

When it is desired to disassemble the hose coupling assembly 10 from the hose H, the nipple 14 is unthreaded from the socket 12 and withdrawn therefrom. Then, the hose H is unthreaded from the socket 12 and withdrawn therefrom. Because of the threaded connection between the socket 12 and the nipple 14, the hose coupling assembly can be reusable.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

1. A hose coupling assembly for attachment to a hose having an inner surface and an outer surface, the hose coupling assembly comprising:
a first member having a tapered outer surface, an outwardly facing groove extending inwardly from the tapered outer surface, and a set of external threads disposed rearward of the tapered outer surface;
an annular seal positioned within the groove; and
a second member having a first receiving portion and a second receiving portion, the first receiving portion having a set of internal threads configured to mesh with and threadingly engage the external threads on the first member, the second receiving portion having a retaining formation that engages the outer surface of the hose and secures the second member to the hose,
wherein, upon insertion of the first member into the first receiving portion of the second member and the subsequent threading of the external threads of the first member into the set of internal threads in the second member, the annular seal on the first member sealingly engages the inner surface of the hose.

2. The hose coupling assembly of claim 1, wherein the first member is configured as a nipple.

3. The hose coupling assembly of claim 2, wherein the nipple includes an outer surface having at least two flats configured to be engaged by a wrench.

4. The hose coupling assembly of claim 2, further comprising a hexagonal nut crimped to a trailing portion of the nipple.

5. The hose coupling assembly of claim 1, wherein the second member is configured as a socket.

6. The hose coupling assembly of claim 5, wherein the socket includes an outer surface having at least two flats configured to be engaged by a wrench.

7. The hose coupling assembly of claim 5, wherein the second set of internal threads in the socket have a trapezoidal-shaped profile.

8. The hose coupling assembly of claim 1, wherein the groove is oriented substantially perpendicular to a longitudinal axis of the hose coupling assembly.

9. The hose coupling assembly of claim 1, wherein the retaining formation includes a set of internal threads.

10. The hose coupling assembly of claim 1, wherein the retaining formation includes a plurality of radially inward extending protrusions.

11. A nipple assembly for use with a socket having a nipple receiving portion and a hose receiving portion secured to a hose having an inner surface and an outer surface, the nipple receiving portion having a set of internal threads, the nipple assembly comprising:
a nipple having a tapered outer surface, an outwardly facing groove extending inwardly from the tapered outer surface, and a set of external threads disposed rearward of the tapered outer surface, the set of external threads configured to mesh with and threadingly engage the internal threads in the socket; and
an annular seal positioned within the groove,
wherein, upon insertion of the nipple into the nipple receiving portion of the socket and the subsequent threading of the external threads of the nipple into the internal threads in the socket, the annular seal on the nipple sealingly engages the inner surface of the hose.

12. The nipple assembly of claim 11, wherein the groove is oriented substantially perpendicular to a longitudinal axis of the hose coupling assembly.

13. The nipple assembly of claim 11, wherein the nipple includes an outer surface having at least two flats configured to be engaged by a wrench.

14. The nipple assembly of claim 11, further comprising a hexagonal nut crimped to a trailing portion of the nipple.

15. The nipple assembly of claim 11, wherein the annular seal extends beyond the tapered outer surface of the nipple.

16. A hose coupling assembly for attachment to a hose having an inner surface and an outer surface, the hose coupling assembly comprising:
a nipple having a tapered outer surface, an outwardly facing groove extending inwardly from the tapered outer surface, and a set of external threads disposed rearward of the tapered outer surface;
an annular seal positioned within the groove; and
a socket having a nipple receiving portion and a hose receiving portion secured to the outer surface of the hose, the nipple receiving portion having a set of internal threads configured to mesh with and threadingly engage the external threads on the nipple,
wherein, upon insertion of the nipple into the nipple receiving portion of the socket and the subsequent threading of the external threads of the nipple into the internal threads in the socket, the annular seal on the nipple sealingly engages the inner surface of the hose.

17. The hose coupling assembly of claim 16, wherein the groove is oriented substantially perpendicular to a longitudinal axis of the hose coupling assembly.

18. The hose coupling assembly of claim 16, wherein the nipple includes an outer surface having at least two flats configured to be engaged by a wrench.

19. The hose coupling assembly of claim 16, further comprising a hexagonal nut crimped to a trailing portion of the nipple.

20. The hose coupling assembly of claim 16, wherein the socket includes an outer surface having at least two flats configured to be engaged by a wrench.
